(19) United States
(12) Patent Application Publication
(10) Pub. No.: US 2006/0081819 A1
(43) Pub. Date: Apr. 20, 2006

(54) Modified electrically conductive adhesives

(76) Inventors: Yi Li, Atlanta, GA (US); Kyoung-sik Moon, Duluth, GA (US); C. P. Wong, Berkely Lake, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/251,240

(22) Filed: Oct. 14, 2005

Related U.S. Application Data
(60) Provisional application No. 60/618,759, filed on Oct. 14, 2004.

(51) Int. Cl. H01B 1/12

(52) U.S. Cl. 252/500

(57) ABSTRACT

Modified electrically conductive adhesives and methods of preparing thereof, are disclosed.

### CROSS-REFERENCE TO RELATED APPLICATION

This application claims priority to co-pending U.S. provisional application entitled, “Aldehydes For High Performance ECAs,” having Ser. No. 60/618,759, filed Oct. 14, 2004, which is entirely incorporated herein by reference.

### STATEMENT REGARDING FEDERALLY SPONSORED RESEARCH OR DEVELOPMENT

The U.S. government may have a paid-up license in this invention(s) and the right in limited circumstances to require the patent owner to license others on reasonable terms as provided for by the terms of RD-83148901-0 awarded by the Environmental Protection Agency of the U.S. Government.

### TECHNICAL FIELD

The present disclosure is generally related to adhesives and, more particularly, embodiments of the present disclosure are related to modified electrically conductive adhesives.

### BACKGROUND

With the phasing out of lead-containing solders, electrically conductive adhesives (ECAs) have been identified as an environmentally friendly alternative to tin/lead (Sn/Pb) solders in electronics packaging applications. ECAs possess numerous advantages, such as fewer processing steps that reduces the processing cost, lower processing temperature that makes use of heat-sensitive and low cost components and substrates possible, and fine pitch capability. However, compared to the mature soldering technology, there are several limitations for conductive adhesives, such as relatively lower conductivity and unstable contact resistance.

Of the conductive adhesives, isotropic conductive adhesives (ICAs) are mainly composed of polymer matrix and conductive fillers. Typical filler loadings are 25 to 30 volume percent for the μm size silver flakes. At these loadings, the materials have achieved the percolation threshold and are electrically conductive in all directions after the materials are cured.

Silver flakes coated with a surfactant (e.g., stearic acids, C-18 carboxylic acids) are widely used as the conductive fillers in most ICA formulations. The presence of such organic lubricants can reduce the viscosity of conductive adhesive pastes and prevent agglomeration of silver flakes, but it can also decrease the conductivity of the ICAs due to the insulative property of the surfactant. Thus, there is a need in the art to provide improved ECAs.

### SUMMARY

Modified electrically conductive adhesives and methods of making such adhesives are disclosed. A representative embodiment of a modified electrically conductive adhesive, among others, includes an electrically conductive adhesive, and a reducing agent additive, where the cured composition has a bulk resistivity from about 10⁻² Ohm-cm to 10⁻⁶ Ohm-cm.

Another representative embodiment of a modified electrically conductive adhesive, among others, includes: a matrix resin, a cross-linking agent, a conductive filler, and a reducing agent. The reducing agent is selected from one of the following formula: R1-CHO, R2-(OH)ₘ, R3-(COOH)ₙ, and R4-CH(NH₂)(COOH). Each of R1, R2, R3, and R4 are independently selected from one of the following: a substituted or unsubstituted, saturated or unsaturated, aliphatic hydrocarbon radical; a substitute or unsubstituted aromatic hydrocarbon radical; a substituted or unsubstituted cycloaliphatic hydrocarbon radical; and a substituted or unsubstituted aryaliphatic hydrocarbon radical. The subscript m is greater than or equal to 1 and the subscript n is from 1 to 3.

### BRIEF DESCRIPTION OF THE DRAWINGS

Many aspects of this disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A through 1C illustrates embodiments of various chemicals.

FIG. 2 illustrates the thermogravimetric analysis curves of Ag flakes before and after treating with aldehydes.

FIG. 3 illustrates the thermogravimetric analysis curves of aldehydes.

FIG. 4 illustrates the curing behavior of the ECAs with aldehydes.

FIG. 5 illustrates the effects of aldehydes on the conductivity of ECA.

FIG. 6 illustrates the contact resistance shifts of ECAs with aldehydes on a Sn surface.

FIG. 7 illustrates the effect of aldehyde on the viscosity of ECA.

FIG. 8 illustrates the storage modulus (a) and tan delta (b) of cured ECAs without and with the aldehyde.

FIG. 9 illustrates the dimension changes of cured ECAs without and with the aldehyde.

### DETAILED DESCRIPTION

Before the embodiments of the present disclosure are described in detail, it is to be understood that unless otherwise indicated the present disclosure is not limited to particular materials, reagents, reaction materials, manufacturing processes, or the like, as such may vary. It is also to be understood that the terminology used herein is for purposes of describing particular embodiments only, and is not intended to be limiting. It is also possible in the present disclosure that steps may be executed in different sequence where this is logically possible.

It must be noted that, as used in the specification and the appended claims, the singular forms “a,” “an” and “the” include plural referents unless the context clearly dictates otherwise.

Definitions

The term “aliphatic hydrocarbon” and “alkyl” refer to straight or branched chain, substituted or unsubstituted, hydrocarbon groups having 1 to 26, 1 to 12, 1 to 8, and 1 to 6 carbon atoms, such as methyl, ethyl, n-propyl, i-propyl, n-butyl, i-butyl, t-butyl, pentyl, hexyl, heptyl, octyl, and the like.

“Unbranched” refers to a structure where the carbon chain does not have any tertiary or quaternary aliphatic carbon atoms.

“Branched” refers to those carbon chains having at least one tertiary or quaternary aliphatic carbon atom.

As used herein, the term “substituted” is used to refer, generally, to a carbon or suitable heteroatom having a hydrogen or other atom removed and replaced with a further moiety. Moreover, it is intended that the term “substituted” refers to substitutions that do not change the basic and novel utility of the underlying compounds, products or compositions of the present disclosure.

The term “substituted alkyl” refers to alkyl groups substituted with one or more groups, preferably selected from aryl, substituted aryl, heterocyclo, substituted heterocyclo, carbocyclo, substituted carbocyclo, halo, hydroxy, alkoxy (optionally substituted), aryloxy (optionally subsituted), alkylester (optionally substituted), arylester (optionally substituted), alkanoyl (optionally substituted), aryol (optionally substituted), cyano, nitro, amino, substituted amino, amido, lactam, urea, urethane, sulfonyl, and the like

The term “cycloalkyl” or “cycloaliphatic hydrocarbon” refers to a saturated hydrocarbon ring group having from 3 to 12 or from 3 to 8 carbon atoms and includes, for example, cyclopropyl, cyclobutyl, cyclohexyl, methylcyclohexyl, cyclooctyl, and the like. Typically, however, cycloalkyl species contain 5 or 6 carbon atoms.

The terms “aromatic hydrocarbon” refer to aromatic homocyclic (i.e., hydrocarbon) mono-, bi- or tricyclic ring-containing groups preferably having 6 to 12 members.

The term “arylaliphatic hydrocarbon” refers to a cyclic hydrocarbon (e.g., mono-, bi- or tricyclic ring-containing groups) having 6 to 12 members such as phenyl, naphthyl and biphenyl arylaliphatic hydrocarbon.

The term “substituted aryl” refers to aryl groups substituted with one or more groups, preferably selected from alkyl, substituted alkyl, alkenyl (optionally substituted), aryl (optionally substituted), heterocyclo (optionally substituted), halo, hydroxy, alkoxy (optionally substituted), aryloxy (optionally substituted), alkanoyl (optionally substituted), aroyl, (optionally substituted), alkylester (optionally substituted), arylester (optionally substituted), cyano, nitro, amino, substituted amino, amido, lactam, urea, urethane, sulfonyl, etc., where optionally one or more pair of substituents, together with the atoms to which they are bonded, form a 3 to 7 member ring.

The terms “heterocycle”, “heterocyclic”, “heterocyclic group” or “heterocyclo” refer to fully saturated or partially or completely unsaturated, including aromatic (“heteroaryl”) or nonaromatic cyclic groups (for example, 3 to 13 member monocyclic, 7 to 17 member bicyclic, or 10 to 20 member tricyclic ring systems, preferably containing a total of 3 to 10 ring atoms), which have at least one heteroatom in at least one carbon atom-containing ring. Each ring of the heterocyclic group containing a heteroatom may have 1, 2, 3 or 4 heteroatoms selected from nitrogen atoms, oxygen atoms and/or sulfur atoms, where the nitrogen and sulfur heteroatoms may optionally be oxidized, and the nitrogen heteroatoms may optionally be quaternized. The heterocyclic group may be attached at any heteroatom or carbon atom of the ring or ring system. The rings of multi-ring heterocycles may be either fused, bridged, and/or joined through one or more spiro unions.

The terms “substituted heterocycle”, “substituted heterocyclic”, “substituted heterocyclic group” and “substituted heterocyclo” refer to heterocycle, heterocyclic and heterocyclo groups substituted with one or more groups preferably selected from alkyl, substituted alkyl, alkenyl, oxo, aryl, substituted aryl, heterocyclo, substituted heterocyclo, carbocyclo (optionally substituted), halo, hydroxy, alkoxy (optionally substituted), aryloxy (optionally substituted), alkanoyl (optionally substituted), aroyl (optionally substituted), alkylester (optionally substituted), arylester (optionally substituted), cyano, nitro, amido, amino, substituted amino, lactam, urea, urethane, sulfonyl, and the like, where optionally one or more pair of substituents together with the atoms to which they are bonded form a 3 to 7 member ring.

The terms “halogen” and “halo” refer to fluorine, chlorine, bromine and iodine.

“Optional” or “optionally” indicates that the subsequently described event or circumstance may or may not occur, and that the description includes instances where said event or circumstance occurs and instances where it does not. For example, the phrase “optionally substituted alkyl group” means that the alkyl group may or may not be substituted and that the description includes both unsubstituted alkyl and alkyl where there is substitution.

Discussion

Modified electrically conductive adhesives (MECAs) and methods of making MECAs, are disclosed. The MECAs include a reducing agent additive. The MECAs of the present disclosure are capable of being used to bond electrical components in power, ground, and signal transmissions in electrical packaging. In short, the MECAs replace tin/lead solder in electrical packaging. For example, the MECAs of the present disclosure can find application in interconnection technologies such as, but not limited to, pin-through-hole (PTH), surface mount technology (SMT), ball grid array (BGA), chip scale package (CSP), and flip chip technology. The MECAs of the present disclosure can find application in consumer electronic devices such as, but not limited to, computers, video displays, cell phones, pagers, PDAs, electronic toys, electronic gaming machines, and the like.

The MECAs of the present disclosure are advantageous because they are environmentally friendly, relatively inexpensive, and easy to process; exhibit low thermo-mechanical stress; and have fine pitch capability. In addition, embodiments of the MECAs may provide superior characteristics over currently used MECAs. For example, MECAs of the present disclosure have higher conductivity, lower bulk resistivity, lower contact resistance shift over time, a higher glass transition temperature, enhanced mechanical properties, and a lower coefficient of thermal expansion (CTE), after curing.

Although not intending to be bound by theory, the reducing agent reduces the metal oxide in the MECA and also consumes oxygen and prevents the oxidation of the metal fillers during the curing process. The effect of the reducing agent additive leads to improved electrical properties. The oxidation products of the aldehydes (e.g., carboxylic acids), when partially replacing or removing the surfactant on Ag flakes, helps the electron tunneling and therefore further increases the conductivity of MECAs. Meanwhile, the better electrical properties and the lower CTE have been achieved without adversely affecting the mechanical properties.

The MECAs of the present disclosure include, but are not limited to, an ECA and a reducing agent additive. The ECA can be one of many commercial ECAs known in the art such as, but not limited to, Emerson & Cumming conductive adhesives (XCE 3050, epoxy based conductive adhesives with Ag flakes), Ablestick conductive adhesives (8175, epoxy based conductive adhesives with Ag flakes), 3M™ electrically conductive adhesives 9703, 9713, DowCorning conductive adhesives, and combinations thereof (e.g., silicone-based dimethysiloxane, methyphenylsiloxane, diphenylsiloxane or methytrifluorosiloxane or silicone-epoxy copolymer loaded with silver flakes).

After curing, the MECA has enhanced characteristics relative to some currently used ECAs. The characteristics include, but are not limited to, bulk resistivity, contact resistance shift, coefficient of thermal expansion, glass transition temperature, curing temperature, storage modulus G′, loss modulus G″, Young's modulus, fracture toughness, flexural strain at break, flexural strength, adhesion strength, viscosity, moisture absorption, and thermal stability. It should be noted that selection of the components of the MECA can alter the values of the characteristics and therefore, the MECAs can be designed for particular applications.

Embodiments of the MECA can have a bulk resistivity from about 10⁻² Ohm-cm to 10⁻⁶ Ohm-cm, from about 10⁻² Ohm-cm to 10⁻⁵ Ohm-cm, from about 10⁻² Ohm-cm to 10⁻⁴ Ohm-cm, and from about 10⁻² Ohm-cm to 10⁻³ Ohm-cm.

Embodiments of the MECA can have a contact resistance that changes less than about 30% after 500 hours' aging at 85° C./85% relative humidity, less than about 20% after 500 hours' aging at 85° C./85% relative humidity, less than about 15% after 500 hours' aging at 85° C./85% relative humidity, and less than about 10% after 500 hours' aging at 85° C./85% relative humidity. In addition, the MECA can have a contact resistance that changes less than about 2 to 20% after 500 hours' aging at 85° C./85% relative humidity, less than about 2 to 15% after 500 hours' aging at 85° C./85% relative humidity, and less than about 2 to 10% after 500 hours' aging at 85° C./85% relative humidity.

Embodiments of the MECA can have a coefficient of thermal expansion before the glass transition temperature (Tg) (α1) is reached (CTE, α1) of about 10 parts per million (ppm)/° C. to 80 ppm/° C., about 15 parts per million (ppm)/° C. to 80 ppm/° C., about 20 parts per million (ppm)/° C. to 80 ppm/° C., about 10 parts per million (ppm)/° C. to 70 ppm/° C., about 10 parts per million (ppm)/° C. to 60 ppm/° C., about 10 parts per million (ppm)/C to 50 ppm/° C., about 10 parts per million (ppm)/° C. to 40 ppm/° C., about 10 parts per million (ppm)/° C. to 30 ppm/° C., about 10 parts per million (ppm)/° C. to 25 ppm/° C., and about 15 parts per million (ppm)/° C. to 25 ppm/° C.

Embodiments of the MECA can have a glass transition temperature (Tg) of about 80° C. to 200° C., about 100° C. to 200° C., about 120° C. to 200° C., about 140° C. to 200° C., about 160° C. to 200° C., and about 180° C. to 200° C.

Embodiments of the MECA can have a curing temperature from about 70° C. to 250° C., about 100° C. to 220° C., and about 120° C. to 200° C.

Embodiments of the MECA can have storage modulus G′ of about 1 to 12 GPa, about 2 to 8 GPa, and about 2 to 5 GPa.

Embodiments of the MECA can have loss modulus G″ of about 50 to 500 MPa.

Embodiments of the MECA can have Young's modulus of about 2.8 to 34 GPa, about 5.6 to 22 GPa, and about 5.6 to 14 GPa.

Embodiments of the MECA can have fracture toughness of about 0.8 to 3 MPa*m^{-1/2} for the stress intensity factor (K₁C).

Embodiments of the MECA can have flexural strain at break of about 5 to 10%.

Embodiments of the MECA can have flexural strength of about 150 to 250 MPa.

Embodiments of the MECA can have adhesion strength of about 10 to 90 MPa/cm

Embodiments of the MECA can have viscosity of about 0.3 Pa*s to thousands of Pa*s. It should be noted that viscosity strongly depends on the resin and loading level of conductive fillers.

Embodiments of the MECA can have moisture absorption of about 0.1 to 3 wt % and about 0.5 to 1.5 wt %.

Embodiments of the MECA can have thermal stability of about 100 to 600° C., about 100 to 400° C., and about 100 to 300° C.

The ECA can include, but are not limited to, a matrix resin, a cross-linking agent, and conductive fillers. The matrix resin can include, but is not limited to, an epoxy resin, a cyanate ester, polyimide, silicone, polyurethane, and other thermoplastics (e.g., preimidized polyimides, maleimides, hot melt thermoplastics and the like), silicone-epoxy blends, thermosets, thermoset-thermoplastic blends, and combinations thereof. In addition, the ECA can include other components such as, but not limited to, a curing accelerator, an adhesion promoter, a corrosion inhibitor, and the like.

The epoxy resin can include, but is not limited to, bisphenol-A type epoxy resins, bisphenol-F type epoxy resins, cycloaliphatic epoxy resins, epoxy novolac resins, biphenyl type epoxy resins, naphthalene type epoxy resins, dicyclopentadiene-phenol type epoxy resins, and combinations thereof.

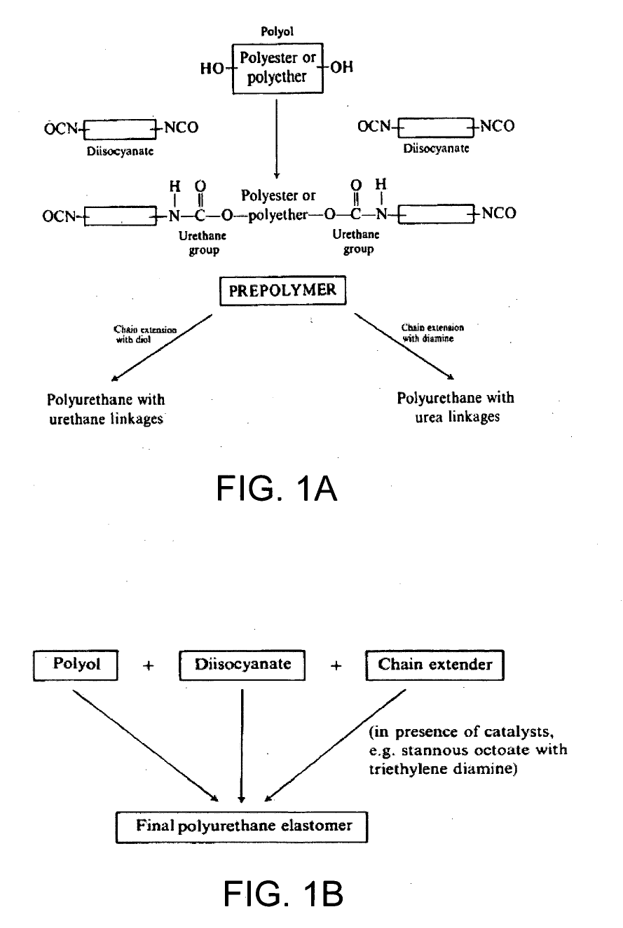

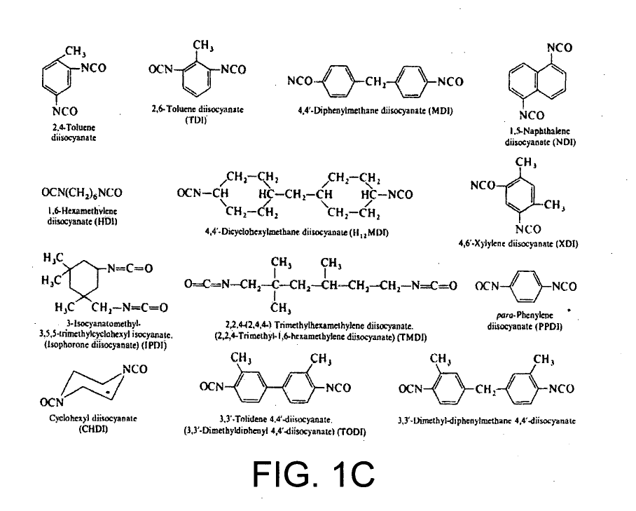

The cyanate ester can include, but is not limited to, those shown in FIGS. 1A-1C. The polyurethane can include, but is not limited to, those shown in FIGS. 1A-1C.

The polyimide, silicone can include, but is not limited to, phenylene pyromellitimide dianhydride (PMDA-ODA), PMDA Benzidine, oxydiphthalic dianhydride (ODPA), dimethysiloxane, methyphenylsiloxane, diphenylsiloxane, methytrifluorosiloxane, silicone-epoxy copolymer, and combinations thereof.

The thermoplastics can include, but are not limited to, preimidized polyimides, maleimides, hot melt thermoplastics, and combinations thereof. The thermoset polymers can include, but are not limited to, epoxies, polyimides, cyanate ester, silicones, and combinations thereof.

The silicone-epoxy blends can include blends such as, but not limited to, dimethysiloxane, methyphenylsiloxane, diphenylsiloxane, trifluoro-methysiloxane, trifluorophenylsiloxane with any epoxy functional groups, and combinations thereof.

The matrix resin is about 2 to 60 by weight percent of the MECA, about 20 to 80 by weight percent of the MECA, and about 40 to 100 by weight percent of the MECA.

The conductive filler can include, but is not limited to, a metal (e.g., silver, nickel, copper, aluminum, palladium, platinum, gold, combinations thereof, and alloys thereof), a carbon black, a carbon fiber, a carbon nanotube, graphite, and combinations thereof. The conductive filler can have particle sizes in the range of about 0.01 micrometers to about 50 micrometers, and about 1 micrometer to about 10 micrometers. The conductive filler is about 5 to 95 by weight percent of the MECA, about 5 to 85 by weight percent of the MECA, and about 60 to 90 by weight percent of the MECA.

The cross-linking agent can include compounds suitable for hardening the MECA composition such as, but not limited to, amines (e.g., tertiary amines aliphatic amines, and aromatic amines), anhydrides (e.g., carboxylic acid anhydrides), thiols, alcohols, phenols, isocyanates, boron complexes, inorganic acids, hydrazides, and imidazoles. In addition, the hardener can include derivatives of the compounds listed above for the cross-linking agent. The cross-linking agent is about 2 to 50 by weight percent of the MECA, about 5 to 90 by weight percent of the MECA, and about 30 to 100 by weight percent of the MECA.

The reducing agent additive can include, but is not limited to, aldehydes, carboxylic acids, glycols, glucose, amino acids, and combinations thereof. The aldehydes can include, but are not limited to, salicylaldehyde, trans-cinnamaldehyde, propionaldehyde, phenylpropargyl aldehyde, and pyridinecarboxaldehyde. The carboxylic acids can include, but are not limited to, malonic acid, glutaric acid, adipic acid, heptanoic acid, terephthalic acid, and dodecanedioic acid. The glycols can include, but are not limited to, ethylene glycol, glycose, and fructose. The amino acids can include, but are not limited to, glycine, lysine, and aspartic acid.

The reducing agent additive can include, but is not limited to, compounds having: the formula R1-CHO, the formula R2-(OH)ₘ, the formula R3-(COOH)ₙ, and the formula R4-CH(NH₂)(COOH). Each of R1, R2, R3, and R4 are independently selected from a substituted or unsubstituted, saturated or unsaturated, aliphatic hydrocarbon radical; a substitute or unsubstituted aromatic hydrocarbon radical; a substituted or unsubstituted cycloaliphatic hydrocarbon radical; and a substituted or unsubstituted aryaliphatic hydrocarbon radical. The subscript “m” is greater than or equal to about 1, and subscript “n” is about 1 to 3. In an embodiment, the molecular length of the reducing agent additive is less about than 50 Å, less than about 40 Å, and less than about 30 Å.

The compounds having the formula R1-CHO can include, but are not limited to, salicylaldehyde, trans-cinnamaldehyde, propionaldehyde, phenylpropargyl aldehyde, pyridinecarboxaldehyde, and combinations thereof.

The compounds having the formula R2-(OH)ₘ can include, but are not limited to, ethylene glycol, glycose, fructose, and combinations thereof.

The compounds having the formula R3-(COOH)ₙ can include, but are not limited to, malonic acid, glutaric acid, adipic acid, heptanoic acid, terephthalic acid, dodecanedioic acid, and combinations thereof.

The compounds having the formula R4-CH(NH₂)(COOH) can include, but are not limited to, glycine, lysine, aspartic acid, proline, and combinations thereof.

The reducing agent additive is about 0.01 to 20 by weight percent of the MECA, about 0.1 to 15 by weight percent of the MECA, about 0.1 to 12 by weight percent of the MECA, and about 0.1 to 8 by weight percent of the MECA.

The curing accelerator can be selected from, but is not limited to, a triphenylphosphine, alkyl-substituted imidazoles, imidazolium salts, onium borates, metal chelates or a mixture thereof. The curing accelerator is present in an amount from about 0 to 10 weight percent of the MECA and about 0 to 2 weight percent of the MECA.

The adhesion promoter is a material that promotes the adhesion between the substrate and the adhesives. Exemplary adhesion promoters include, but are not limited to, organafinctional saline adhesion promoters. The adhesion promoter material is present in an amount of about 0 to 10 weight percent of the MECA and about 0.1 to 2 weight percent of the MECA.

The corrosion inhibitor is a material that prevents oxidation and corrosion of metal surfaces and stabilizes contact resistance of electrically conductive adhesives during elevated temperature and humidity. Exemplary corrosion inhibitors include, but are not limited to, chelating compounds, imidazole derivatives, phenyl-substituted imidazole, benzo-triazole and its derivatives, and acids. The corrosion inhibitor material is present in an amount of about 0.01 to 10 weight percent of the MECA and about 0.1 to 3 weight percent of the MECA.

The components of the MECA can be mixed and applied to a substrate to which solder can be disposed, and then cured. The curing can be performed at about 120 to 160° C. for about 60 to 90 minutes. The cured MECA has the characteristics as described above.

Now having described the MECAs in general, an example of a possible embodiment of the MECAs will be discussed. While embodiments of the MECAs are described in connection with the example and the corresponding text and figures, there is no intent to limit embodiments of the MECAs to these descriptions. On the contrary, the intent is to cover all alternatives, modifications, and equivalents included within the spirit and scope of embodiments of the present disclosure.

It should be emphasized that the above-described embodiments of the present disclosure are merely possible examples of implementations and are merely set forth for a clear understanding of the principles of the disclosure. Many variations and modifications may be made to the above-described embodiments. All such modifications and variations are intended to be included herein within the scope of this disclosure and protected by the following claims.

### EXAMPLE

Electrically conductive adhesives (ECAs) have been proposed as one of the major alternatives for tin/lead solders in electronic packaging. However, the conductivity of ECA is inferior to that of solders due to the physical contact between conductive fillers and insulative organic lubricants on Ag flakes.

In this disclosure, novel aldehydes were introduced into a typical ECA formulation. During the curing process, the aldehydes acted as a reducing agent and reduced metal oxide within MECAs. At the same time, the aldehydes could consume ambient oxygen and prevent the oxidation of the metal fillers in the ECA. The oxidation product of aldehydes, carboxylic acids with shorter molecular chains, could partially replace or remove the long chain steric acid (C-18) surfactant on the Ag flakes and enhance the electrons tunneling between the Ag flakes in the MECAs. As such, the multiple effects of aldehydes in ECAs improved the conductivity significantly. Dynamic mechanical analysis (DMA) and thermomechanical analysis (TMA) studies indicated the improved electrical performance was achieved without sacrificing the mechanical and physical properties of ECAs.

Experimental

A commercially available ECA (XCE 3050 from Emerson & Cumming) was used as a base formulation. Two different types of aldehydes, salicylaldehyde (ALD 1) and trans-cinnamaldehyde) ALD 2, were added into the ECA and mixed, respectively. After preparing the samples, the curing behaviors were determined using a modulated differential scanning calorimeter (MDSC) from TA Instruments, model 2970. The dynamic scans were made on the samples in nitrogen at a heating rate of 5° C./minute, usually from 25° C. to 250° C.

Resistivity of the MECAs was calculated from the bulk resistance of the specimen with specific dimensions. Two strips of an adhesive tape were applied on a pre-cleaned glass slide with a gap width of 6.62 mm between these two strips. The conductive adhesive paste was then doctor-bladed within the gap space, and then the tapes were removed. After cure, the bulk resistance (R) of the ICA strips was measured as well as the size of the specimen. The bulk resistivity, p, was calculated using following equations:

$$ρ = \frac{t \times w}{l} \times R$$

where l, w, t are the length, width and thickness of sample, respectively.

Contact resistance of a specimen was measured with a Keithley 2000 multimeter. The specimens were aged under 85° C./85% RH by using a temperature/humidity chamber (Lunaire Environmental, model CEO932W-4). The contact resistance of each specimen was measured periodically during aging.

To characterize the reaction between aldehydes and Ag flakes during the heating process, the weight loss of silver flakes before and after treatment in aldehyde solutions was measured using a thermogravimetry analyzer (TGA, TA Instruments, model 2050). The temperature was raised from 25° C. to 500° C. at a heating rate of 10° C./minute. One mM aldehyde solutions were prepared to treat the Ag flakes, and the treating time was 24 hours. After treatment, the Ag flakes were removed from the solution and rinsed with ethanol in order to remove excess aldehyde. The solvent was then dried out under controlled nitrogen.

The rheological study of the ECA was conducted with a stress-controlled rheometer from TA Instruments, model AR1000-N. A 4-cm steel parallel plate fixture was used in the study. The gap between two plates was set at 300 um. The viscosity of the adhesive formulations was measured at room temperature under an oscillation mode.

Dynamic mechanical properties of cured conductive adhesives were investigated using a dynamic mechanical analyzer (DMA) from TA Instruments, model 2980, with a film tension clamp. After a sample was mounted on the clamp, the temperature was raised from 25° C. to 200° C. at a heating rate of 3° C./minute. The sample was studied under an oscillation mode with a frequency of 1 Hz. Storage modulus and tan delta versus temperature were recorded.

Coefficient of thermal expansions (CTEs) and glass transistion temperatures (Tgs) of ECA samples were measured with a thermomechnical analyzer (TMA) from TA Instruments, model 2940. An expansion probe was used and a static force applied on this probe was set to 0.050 Newton. Temperature was ramped from 25° C. to 200° C. at a heating rate of about 5° C./min. The dimension change with temperature was recorded. The slope of the straight line below the Tg was calculated as the CTE, α1, of the sample.

Results and Discussion

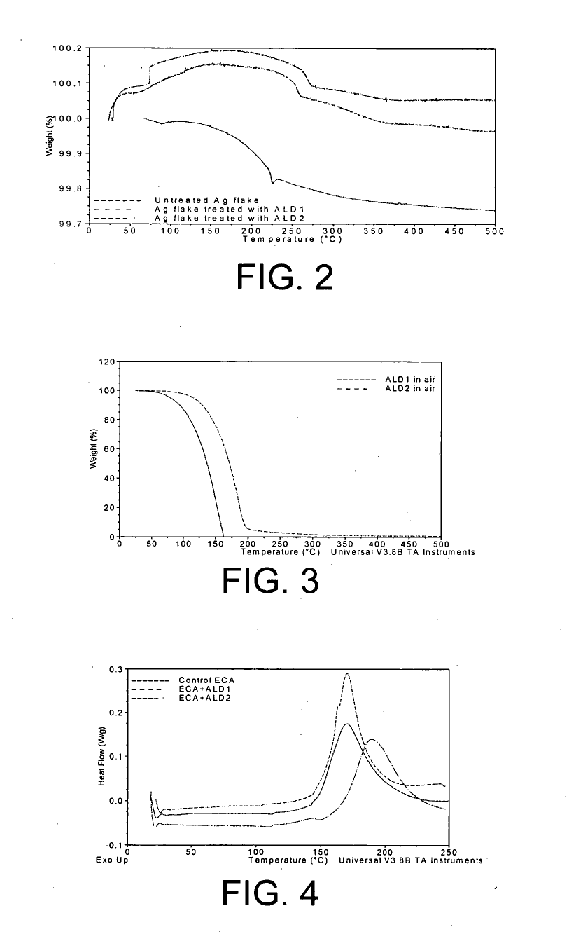

The weight loss of silver flakes before and after treatment in aldehyde solutions was studied using a thermogravimetry analyzer (TGA) (FIG. 2). For the untreated Ag flakes, obvious weight loss over 0.2% was observed at temperatures ranging from 150 to 250° C., due to the presence of organic lubricants on the Ag flakes. After treated in aldehyde solutions, the Ag flakes firstly showed increased weight around 0.1-0.2% at lower temperatures of 50-100° C. This indicates that the aldehyde has been coated on the Ag flake surfaces after treatment. At these temperatures, the coated aldehyde may be oxidized to carboxylic acid, therefore leading to the increased weight. (Equation 1).
2R—CHO+O₂→2R—COOH (1)

The treated Ag flakes, after increasing weight at lower temperature, then showed around 0.1% weight loss at higher temperatures similar to those for untreated samples (150-250° C.). However, the amount of weight loss was lower than that of untreated Ag flakes. Therefore, the surfactant on Ag flakes has been partially replaced or removed by the formed carboxylic acids which have lower pKa values than stearic acid. Lower Pka value indicates stronger acidity and therefore better affinity to Ag flakes.

Although an initial obvious weight increase was found for Ag flakes treated with aldehyde, a similar phenomenon could not be observed for aldehyde itself. (FIG. 3). The final weight loss at around 100° C. and 170° C. for the aldehydes corresponded to their evaporation/decomposition. Thus, the oxidation of aldehyde at relatively lower temperatures might be catalyzed by Ag flakes.

FIG. 4 illustrates the curing profile of ECAs before and after the addition of aldehydes. All MECAs showed similar curing behaviors and had exothermic peak temperatures ranging from 150 to 200° C. The total reaction heat of the curing of MECAs slightly decreased after the addition of aldehydes (Table 1). The change was negligible compared to that observed for dicarboxylic acids, indicating that there was no severe reaction between MECAs and aldehydes during the mixing process at room temperature and that pre-mature curing did not happen, which could affect the pot-life and self-life of the MECAs.

TABLE 1
Curing profile of MECA with Aldehydes

| | Peak temperature | Reaction heat |
|---|---|---|
| Formulations | (° C.) | (J/g) |
| ECA control | 170 | 92 |
| ECA + ALD 1 | 170 | 85 |
| ECA + ALD 2 | 188 | 83 |

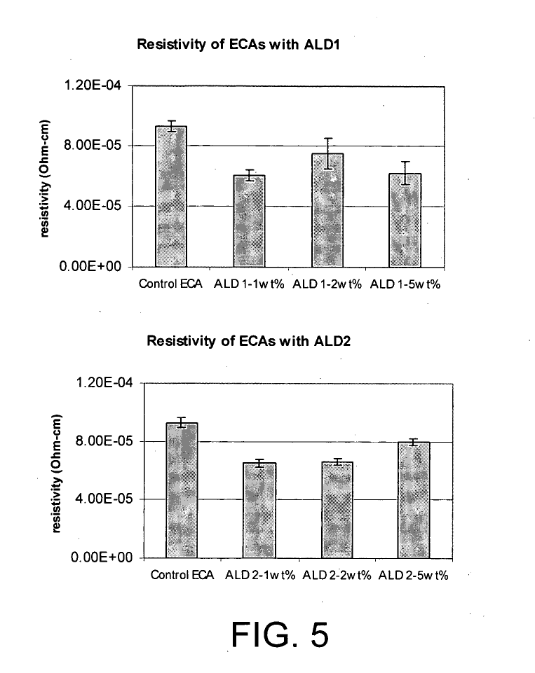

The bulk resistivity of MECAs with different loading levels of ALD1 and ALD2 is shown in FIG. 5. The resistivity of MECAs was dramatically decreased by incorporating aldehydes. The best results were achieved for MECAs with 1 wt % of aldehydes, for which the conductivity of MECAs was improved over 40% and 30% for AlD1 and ALD2, respectively. By introducing aldehydes into MECAs, the bulk resistivity could be achieved as low as 6×10⁻⁵ Ohm-cm, which is comparable to that of eutectic solders (10⁻⁵-10⁻⁴ Ohm-cm). The possible mechanism for the improvement of conductivity is due to the reducing effects of aldehydes. The aldehydes could reduce the metal oxides that exist on the surface of metal fillers in MECAs during the curing process. (Equation 2). Therefore, the oxidation of aldehydes and the subsequent reduction of the silver oxide to silver resulted in the conductivity improvement.
R—CHO+Ag₂O→R—COOH+2Ag (2)

Another contribution of aldehydes to the conductivity improvement is due to their consumption of oxygen during heating. From the TGA results (FIG. 2 and equation 1), it was observed that the aldehydes could consume oxygen and be oxidized to carboxylic acid in the presence of Ag flakes. Thus, the metal fillers in MECAs were prevented from oxidation due to the depletion of oxygen. The oxidation product of aldehydes, carboxylic acids, which are stronger acids and have shorter molecular length than C-18 stearic acid, can partially replace or remove the stearic acid on Ag flakes. The connection of silver flakes with short chain carboxylic acid facilitates electron transport along the chain and helps electrons tunnelling between those Ag flakes. Furthermore, the resulting carboxylic acid can also act as a reducing agent and keep the metal fillers from oxidation and maintain higher conductivity of the MECA. The multiple functions of aldehydes in MECAs thereby improved the electrical conductivity significantly.

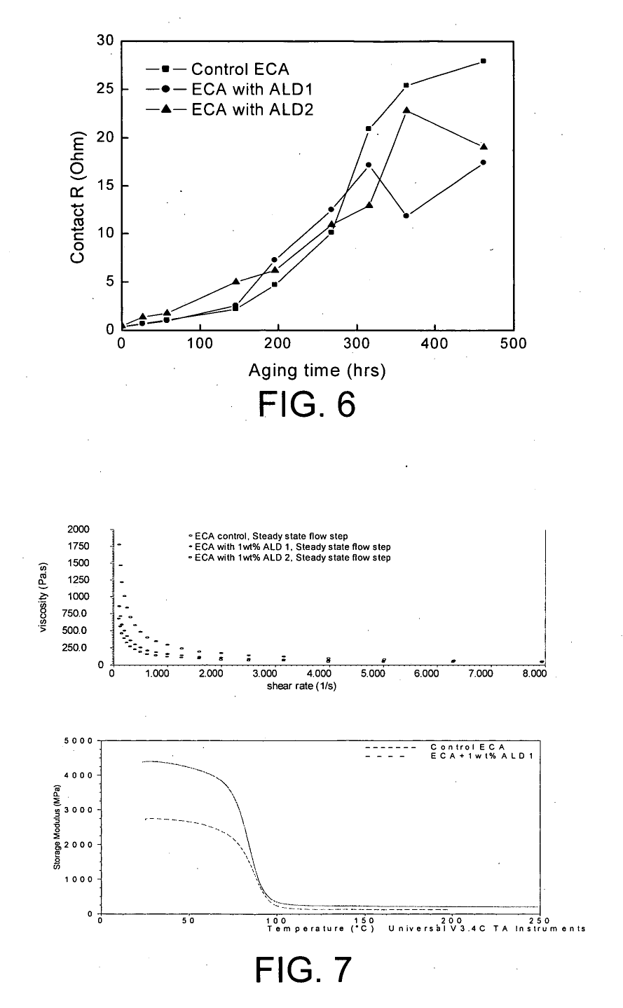

The effects of the aldehydes on contact resistance were also investigated. The contact resistance shifts of MECAs on a Sn surface with and without aldehydes during 85° C./85% RH aging are shown in FIG. 6. The MECA/Sn surface joint has shown unstable contact resistance under harsh environment due to corrosion. In this example, increased contact resistance for all the samples was observed as shown in FIG. 6. Nevertheless, with a longer aging time, the contact resistance of MECAs with aldehydes was slightly lower than that of a control sample. This could be attributed to the formed carboxylic acids that served as reducing agent to maintain good metallic contact and slow down the interfacial corrosion. But to get a more satisfactory stabilized contact resistance, suitable corrosion inhibitors or sacrificial anodes have to be incorporated to achieve highly reliable adhesives.

Viscosity of MECAs reflects the interaction between ingredients in the formulation and also the processibility of the composite materials. Dicarboxylic acids in MECAs demonstrated increased viscosity and caused significant processing issues after using the acids. For the aldehyde added MECAs, however, the viscosity did not change much and even decreased slightly (attributed to the lower viscosity of the added aldehydes). (FIG. 7). This is very important when considering the processibility of MECAs.

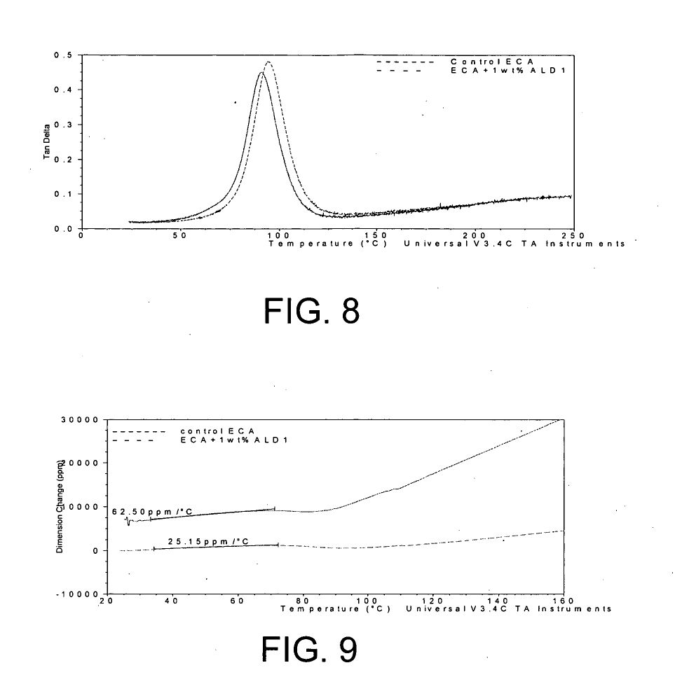

The mechanical properties after the addition of aldehydes were also investigated. FIG. 8 shows the storage modulus and tan δ value changes as a function of temperature. The storage modulus decreased after using aldehyde, and therefore, an increased tan δ value was obtained, which suggested a higher toughness and better impact performance of the MECA composite. Also, the higher storage modulus of the cured polymers at temperature 30° C. higher than Tg indicated an increased cross-linking density.

Coefficient of Thermal Expansion (CTE) of the cured MECAs was measured using a thermomechanical analyzer (TMA). (FIG. 9). The CTE values before Tg (CTE α1) of ECAs without and with addition of aldehyde were 62.50 ppm/° C. and 25.15 ppm/° C., respectively. The dramatically decreased α1 is due to more interactions between Ag—Ag and between Ag-epoxy of the aldehyde added MECAs. The more filler-polymer interaction, the less free volume within the cured epoxy composite matrix material, and also less likely for the epoxy chain to slip by during the heating process and resulted in a lower CTE value with increasing temperatures. Furthermore, a lower CTE of the MECA will reduce the thermomechanical stress of the MECA to the PWB substrate (CTE about 16-24 ppm) interconnect structure. This lowered stress can enhance the temperature cycle reliability of the interconnection. The details for the decreased CTE will be discussed elsewhere.

### CONCLUSIONS

Novel aldehydes were used in a typical MECA formulation to improve the electrical performance. The aldehydes could act as a reducing agent for metal oxide in MECAs and also consume oxygen and prevent the oxidation of the metal fillers during the curing process. The effect of the reducing agent could lead to the improved electrical properties. The oxidation products of aldehydes, carboxylic acids, when partially replacing or removing the surfactant on Ag flakes, helped the electron tunneling and therefore further increased the conductivity of ECAs. Meanwhile, the better electrical properties and the lower CTE have been achieved without adversely affecting the mechanical properties.

Therefore, at least the following is claimed:

1. A composition, comprising:
an electrically conductive adhesive (ECA); and
a reducing agent additive, wherein the cured composition has a bulk resistivity from about 10⁻² Ohm-cm to 10⁻⁶ Ohm-cm.

2. The composition of claim 1, wherein the reducing agent additive is an aldehyde additive.

3. The composition of claim 1, wherein the aldehyde additive has the formula R1-CHO, and wherein R1 is selected from a substituted or unsubstituted, saturated or unsaturated, aliphatic hydrocarbon radical; a substituted or unsubstituted aromatic hydrocarbon radical; a substituted or unsubstituted cycloaliphatic hydrocarbon radical; and a substituted or unsubstituted aryaliphatic hydrocarbon radical.

4. The composition of claim 1, wherein the aldehyde additive is selected from salicylaldehyde, trans-cinnamaldehyde, propionaldehyde, phenylpropargyl aldehyde, and pyridinecarboxaldehyde.

5. The composition of claim 1, wherein the reducing agent additive includes a carboxylic acid additive.

6. The composition of claim 1, wherein the carboxylic acid additive has the formula R3-(COOH)ₙ, and wherein n is from 1 to 3, wherein R3 is selected from a substituted or unsubstituted, saturated or unsaturated, aliphatic hydrocarbon radical; a substituted or unsubstituted aromatic hydrocarbon radical; a substituted or unsubstituted cycloaliphatic hydrocarbon radical; and a substituted or unsubstituted aryaliphatic hydrocarbon radical.

7. The composition of claim 1, wherein the reducing agent additive is an amino acid additive.

8. The composition of claim 1, wherein the amino acid additive has the formula R4-CH(NH₂)(COOH), and wherein R4 is selected from a substituted or unsubstituted, saturated or unsaturated, aliphatic hydrocarbon radical; a substituted or unsubstituted aromatic hydrocarbon radical; a substituted or unsubstituted cycloaliphatic hydrocarbon radical; and a substituted or unsubstituted aryaliphatic hydrocarbon radical.

9. The composition of claim 1, wherein the reducing agent additive has the formula R2-(OH)ₘ, wherein m is greater than or equal to 1, and wherein R2 is selected from a substituted or unsubstituted, saturated or unsaturated, aliphatic hydrocarbon radical; a substituted or unsubstituted aromatic hydrocarbon radical; a substituted or unsubstituted cycloaliphatic hydrocarbon radical; and a substituted or unsubstituted aryaliphatic hydrocarbon radical.

10. The composition of claim 1, wherein a contact resistance of the cured composition changes less than about 20% after 500 hours' aging at 85° C./85% relative humidity.

11. The composition of claim 1, wherein the cured composition has a coefficient of thermal expansion before the glass transition temperature (Tg) is reached (CTE, α1) of about 10 parts per million (ppm)/° C. to 80 ppm/° C.

12. The composition of claim 1, wherein the cured composition has a glass transition temperature (Tg) about from 80° C. to 200° C.

13. A modified electrically conductive adhesive, comprising:
a matrix resin;
a cross-linking agent;
a conductive filler; and
and a reducing agent, wherein the reducing agent is selected from the formula R1-CHO, R2-(OH)ₘ, R3-(COOH)ₙ, and R4-CH(NH₂)(COOH), wherein each of R1, R2, R3, and R4 are independently selected from a substituted or unsubstituted, saturated or unsaturated, aliphatic hydrocarbon radical; a substituted or unsubstituted aromatic hydrocarbon radical; a substituted or unsubstituted cycloaliphatic hydrocarbon radical; and a substituted or unsubstituted aryaliphatic hydrocarbon radical, and wherein m is greater than or equal to 1, and wherein n is from 1 to 3.

14. The modified electrically conductive adhesive of claim 13, wherein the cured modified electrically conductive adhesive has: a bulk resistivity from about 10⁻² Ohm-cm to 10⁻⁶ Ohm-cm, a contact resistance that changes less than about 20% after 500 hours' aging at 85° C./85% relative humidity, a coefficient of thermal expansion before the glass transition temperature (Tg) is reached (CTE, α1) of about 10 parts per million (ppm)/° C. to 80 ppm/° C., and a glass transition temperature (Tg) about from 80° C. to 200° C.

15. The modified electrically conductive adhesive of claim 13, wherein the matrix resin is about 2 to 99 by weight percent of the modified electrically conductive adhesive, the cross-linking agent is about 1 to 50 by weight percent of the modified electrically conductive adhesive, the conductive filler is about 5 to 95 by weight percent of the modified electrically conductive adhesive, and the reducing agent is about 0.01 to 20 by weight percent of the modified electrically conductive adhesive.

16. The modified electrically conductive adhesive of claim 13, wherein the conductive filler is selected from: a metal selected from silver, nickel, copper, aluminum, palladium, platinum, gold, combinations thereof, alloys thereof; a carbon black; a carbon fiber; a carbon nanotube; graphite; and combinations thereof.

17. The modified electrically conductive adhesive of claim 13, wherein the matrix resin is an epoxy resin that is selected from bisphenol-A type epoxy resins, bisphenol-F type epoxy resins, cycloaliphatic epoxy resins, epoxy novolac resins, biphenyl type epoxy resins, naphthalene type epoxy resins, dicyclopentadiene-phenol type epoxy resins, and combinations thereof.
